(19) United States
(12) Patent Application Publication
(10) Pub. No.: US 2018/0181543 A1
(43) Pub. Date: Jun. 28, 2018

(54) METHOD AND APPARATUS FOR THE SENSOR-INDEPENDENT REPRESENTATION OF TIME-DEPENDENT PROCESSES

(71) Applicant: David Levin, Chicago, IL (US)

(72) Inventor: David Levin, Chicago, IL (US)

(21) Appl. No.: 15/831,694

(22) Filed: Dec. 5, 2017

Related U.S. Application Data
(60) Provisional application No. 62/498,503, filed on Dec. 27, 2016.

(51) Int. Cl. G06F 17/18

(52) U.S. Cl. CPC G06F 17/18

(57) ABSTRACT

This disclosure shows how a time series of measurements of an evolving system can be processed to create an “inner” time series that is unaffected by any instantaneous invertible, possibly nonlinear transformation of the measurements. An inner time series contains information that does not depend on the nature of the sensors, which the observer chose to monitor the system. Instead, it encodes information that is intrinsic to the evolution of the observed system. Because of its sensor-independence, an inner time series may produce fewer false negatives when it is used to detect events in the presence of sensor drift. Furthermore, if the observed physical system is comprised of non-interacting subsystems, its inner time series is separable; i.e., it consists of a collection of time series, each one being the inner time series of an isolated subsystem. Because of this property, an inner time series can be used to detect a specific behavior of one of the independent subsystems without using blind source separation to disentangle that subsystem from the others. The method is illustrated by applying it to: 1) an analytic example; 2) the audio waveform of one speaker; 3) mixtures of audio waveforms of two speakers.

### CROSS REFERENCE TO RELATED APPLICATIONS

This application claims priority to U.S. Provisional Application No. 62/498,503, filed on Dec. 27, 2016, entitled “Method and Apparatus For Model-Independent Nonlinear Blind Source Separation”, the contents of which are incorporated by reference herein in its entirety.

### FIELD OF THE INVENTION

This disclosure relates to software systems, and in particular relates to interpretation of sensor measurements and processing the time series of sensor measurements in order to compute an “inner” time series that describes the evolution of the observed physical system, and that does not depend on the nature of the sensors used to observe it. Therefore, systems and software for interpreting the inner time series need not be recalibrated when the physical system is observed with a variety of sensors.

### BACKGROUND OF THE INVENTION

Consider a physical system that is being observed with a set of sensors. The time series of raw sensor measurements contains information about the evolution of the system of interest, mixed with information about the nature of the sensors. For example, video pictures contain information about the evolution of the scene of interest, but they are also influenced by sensor-dependent factors such as the position, angular orientation, field of view, and spectral response of the camera. Likewise, audio measurements may contain information about the evolution of an acoustic source, but they are also influenced by extrinsic factors such as the positions and frequency responses of the microphones. Calibration procedures can be used to transform measurements created with one set of sensors so that they can be compared to measurements made with a different set of sensors. However, there are situations in which it is inconvenient, awkward, or impossible to calibrate a measurement apparatus. For example: 1) the calibration procedure may take too much time; 2) the calibration process may interfere with the evolution of the system being observed; 3) The observer may not have access to the measuring device (e.g., because it is at a remote location).

This disclosure describes how a time series of measurements can be processed to derive a purely sensor-independent description of the evolution of the underlying physical system. Specifically, consider an evolving physical system with N degrees of freedom (N≥1), and suppose that it is being observed by N sensors, whose output is denoted by x(t) (xₖ(t) for k=1, . . . , N). For simplicity, assume that the sensors' output is invertibly related to the system states. In other words, assume that the sensor measurements represent the system's state in a coordinate system defined by the nature of the sensors. Section 4 describes how measurements can be chosen to have this invertibility property. Now, suppose that the same system is also being observed by another set of sensors, whose output, x′(t), is invertibly related to the system states and, therefore, is invertibly related to x(t). For example, x(t) and x′(t) could be the outputs of calibrated and uncalibrated sensors, respectively, as they simultaneously observe the same system. Or, they could be the outputs of sensors that detect different types of energy (e.g., infrared light vs ultraviolet light). Under these conditions, we show how to process x(t) in order to derive an “inner” time series, w(t) (wₖ(t) for k=1, . . . , N). We then demonstrate that the same inner time series will result if the other set of sensor outputs, x′(t), is subjected to the same procedure. Therefore, the same software can be used to interpret the inner time series derived from measurements made with different sensors. No recalibration procedure is necessary. In mathematical terms, x(t) and x′(t) represent the evolving system's state in different coordinate systems on state space, and the inner time series is a coordinate-system-independent description of the system's path through state space.

To derive this sensor-independent time series, the time series of past sensor measurements, x(t), is statistically processed in order to construct N local vectors at each point in state space. The system's path through state space can then be described by a succession of small displacement vectors, each of which is a weighted superposition of the local vectors. The inner time series is comprised of these time-dependent weights, w(t), which are coordinate-system-independent and, therefore, sensor-independent. Thus, any two observers will describe the system's evolution with the same inner time series, even though they utilize different sensors to monitor the system. Essentially, an inner time series is a “canonical” form of a measurement time series, created by normalizing each measurement with respect to the statistical properties of past measurements. It is roughly analogous to the principal components representation of a data set, which also normalizes each datum with respect to the statistical properties of the entire data set. A principal components representation is unaffected by rotations and translations of the data. However, it is sensitive to nonlinear data transformations, which do not affect an inner time series.

There are many ways of using a time series of measurements to define local vectors on the system's state space, and each of these methods can be used to create a sensor-independent description of the system's evolution. However, the local vectors described in this disclosure have an unusually attractive property: namely, they produce separable sensor-independent descriptions of systems that are composed of non-interacting subsystems. Specifically, consider a system that is composed of two statistically independent subsystems, and suppose that the raw measurements of it are linear or nonlinear mixtures of the state variables of its non-interacting subsystems. It can be shown that each component of the inner time series of the composite system is also a component of the inner time series of an isolated subsystem. In other words, each component of the inner time series of the composite system is a stream of information about just one of the subsystems, even though it may have been derived from measurements sensitive to several subsystems. Because of this property, an inner time series can be used to detect a specific behavior of one subsystem, which is evolving in the presence of other subsystems. In contrast to blind source separation procedures, this is done without finding the unmixing function, which relates the raw measurements of the composite system to the states of its subsystems.

### SUMMARY OF THE INVENTION

As schematically illustrated in FIG. 1, embodiments of the present invention include the following steps to process the measurement time series:
1. The local second- and fourth-order correlations of the measurement velocity (\dot{x}) are computed in small neighborhoods of the measurement space. These correlations are used to compute N local vectors (V₍ᵢ₎(x) for i=1, . . . , N) on the measurement space.
2. The measurement velocity at each time (\dot{x}(t)) is equal to a weighted superposition of these local vectors.
3. The time-dependent weights, wᵢ(t), provide an inner (coordinate-system-independent and sensor-independent) description of the system's path through state space.
4. If the system is composite, the weight components can be partitioned into groups, each of which comprises a sensor-independent and coordinate-system-independent description of a subsystem's path through the state space of that subsystem.
5. The coordinate-system-independent description of the evolving system (or one of its subsystems) provides information about aspects of the system (or subsystem). For example, it may make it possible to recognize when the system (or subsystem) is in a state of special interest.

### BRIEF DESCRIPTIONS OF THE DRAWINGS

FIG. 1 is a pictorial diagram of a specific embodiment of the method and apparatus for creating sensor-independent and coordinate-system-independent representations of time-dependent processes.

FIG. 2 is a graph showing a thin black line depicting a 31.25 ms excerpt of x(t), the audio waveform of a speaker, and showing a thick gray line depicting x′(t), which is the same waveform, after it has been transformed by the monotonic nonlinear transformation shown in FIG. 3.

FIG. 3A is a graph showing the monotonic nonlinear transformation, x′(x), which was applied to the sensor measurements, x(t), in order to create x′(t) (FIG. 2). The latter time series simulates the output of a different sensor.

FIG. 3B is a graph showing a magnified view of the central portion of FIG. 3A.

FIG. 4A is a pictorial illustration of V₍₁₎(x), which was derived from 500,000 samples of x(t).

FIG. 4B is a pictorial illustration of V′₍₁₎(x′), which was derived from 500,000 samples of x′(t).

FIG. 5 is a graph showing a thin black line and a thick gray line depicting the inner time series, w₁(t) and w′₁(t), respectively, during the 31.25 ms time interval depicted in FIG. 2.

FIG. 6A shows the unmixed audio waveform of the first speaker during a 31.25 ms time interval.

FIG. 6B shows the unmixed audio waveform of the second speaker during a 31.25 ms time interval.

FIG. 7 is a warped grid in the x′ coordinate system, obtained by applying the nonlinear mixing function in Eq. (25) to a regular Cartesian grid in the x coordinate system.

FIG. 8A shows one specific mixture of the audio waveforms of the two speakers, obtained by applying the nonlinear mixing function in Eq. (25) to the unmixed waveforms in FIG. 6.

FIG. 8B shows the other mixture of the audio waveforms of the two speakers, obtained by applying the nonlinear mixing function in eqn. Eq. (25) to the unmixed waveforms in FIG. 6.

FIG. 9A shows the one-component local vectors derived from the unmixed waveform, x₁(t), an excerpt of which is illustrated in FIG. 6.

FIG. 9B shows the one-component local vectors derived from the unmixed waveform, x₂(t), an excerpt of which is illustrated in FIG. 6.

FIG. 9C illustrates line segments showing the local vectors derived from the mixed waveforms, x′(t), an excerpt of which is illustrated in FIG. 8. These line segments have been uniformly rescaled for the purpose of display. The small black points show the distribution of randomly chosen samples of the mixed waveforms, x′(t).

FIG. 10A is a graph showing a thin black line and a thick gray line depicting the inner time series, w₁(t) and w′₁(t), derived from the unmixed and mixed waveforms, respectively, during the 31.25 ms time interval depicted in FIG. 6 and FIG. 8.

FIG. 10B is a graph showing a thin black line and a thick gray line depicting the inner time series, w₂(t) and w′₂(t), derived from the unmixed and mixed waveforms, respectively, during the 31.25 ms time interval depicted in FIG. 6 and FIG. 8.

### DETAILED DESCRIPTION OF THE INVENTION

Section 1 below outlines how a time series of sensor measurements can be processed in order to derive local vectors at each point in the state space of the observed system. It is then shown how these vectors can be used to create an inner description of the system's path through state space. In Section 2 below, the system is assumed to be composed of two statistically independent subsystems. It is shown that the inner time series of the composite system is a simple collection of the inner time series of its subsystems. Section 3 below illustrates embodiments of the inventive method in which it is applied to: 1) an analytic example; 2) the audio waveform of one speaker; 3) mixtures of audio waveforms of two speakers. Section 4 below discusses the implications of various embodiments of the invention.

### 1 DERIVATION OF INNER TIME SERIES

The first step is to construct second-order and fourth-order local correlations of the data's velocity (\dot{x})

Cₖₗ(x)= [symbol] (\dot{x}ₖ−\dot{x̅}ₖ)(\dot{x}ₗ−\dot{x̅}ₗ) [symbol] ₓ (1)

Cₖₗₘₙ(x)= [symbol] (\dot{x}ₖ−\dot{x̅}ₖ)(\dot{x}ₗ−\dot{x̅}ₗ)(\dot{x}ₘ−\dot{x̅}ₘ)(\dot{x}ₙ−\dot{x̅}ₙ) [symbol] ₓ (2)

where \dot{x̅}= [symbol] \dot{x} [symbol] ₓ, where \dot{x} is the time derivative of x, where the angular bracket denotes the time average over the trajectory's segments in a small neighborhood of x, and where all subscripts are integers between 1 and N with N≥1.

Next, let M(x) be any local N×N matrix, and use it to define M-transformed velocity correlations, Iₖₗ and Iₖₗₘₙ,

$$\begin{matrix}{I}_{kl} ( x ) = {\sum }_{1 \leq {k}^{′} , {l}^{′} \leq N} {M}_{{kk}^{′}} ( x ) {M}_{{ll}^{′}} ( x ) {C}_{{k}^{′} {l}^{′}} ( x ) , & ( 3 ) \\ {I}_{klmn} ( x ) = {\sum }_{1 \leq {k}^{′} , {l}^{′} , {m}^{′} , {n}^{′} \leq N} {M}_{{kk}^{′}} ( x ) {M}_{{ll}^{′}} ( x ) {M}_{m {m}^{′}} ( x ) {M}_{{nn}^{′}} ( x ) {C}_{{k}^{′} {l}^{′} {m}^{′} {n}^{′}} ( x ) . & ( 4 )\end{matrix}$$

Because Cₖₗ(x) is generically positive definite at any point x, it is almost always possible to find a particular form of M(x) that satisfies

$$\begin{matrix}{I}_{kl} ( x ) = {δ}_{kl} & ( 5 ) \\ {\sum }_{1 \leq m \leq N} {I}_{klmn} ( x ) = {D}_{kl} ( x ) , & ( 6 )\end{matrix}$$

where D(x) is a diagonal N×N matrix. As long as D is not degenerate, M(x) is unique, up to arbitrary local permutations and/or reflections. In almost all applications of interest, the velocity correlations will be continuous functions of x. Therefore, in any neighborhood of state space, there will always be a continuous solution for M(x), and this solution is unique, up to arbitrary global permutations and/or reflections. By construction, M is not singular.

In any other coordinate system x′, the most general solution for M′ is given by

$${M}_{kl}^{′} ( {x}^{′} ) = {\sum }_{1 \leq m , n \leq N} {P}_{k m} {M}_{m m} ( x ) \frac{\partial {x}_{n}}{\partial {x}_{l}^{′}} , \qquad ( 7 )$$

where M is a matrix that satisfies Eq. (5) and Eq. (6) in the x coordinate system and where P is a product of permutation, reflection, and identity matrices.

Notice that Eq. (7) shows that the rows of M transform as local covariant vectors, up to a global permutation and/or reflection. Likewise, the same equation implies that the columns of M⁻¹ transform as local contravariant vectors (denoted as V₍ᵢ₎(x) for i=1, . . . N), up to a global permutation and/or reflection. Because these vectors are linearly independent, the measurement velocity at each time (\dot{x}(t)) can be represented by a weighted superposition of them

$$\dot{x} ( t ) = {\sum }_{1 \leq i \leq N} {w}_{i} ( t ) {V}_{( i )} ( x ) , \qquad ( 8 )$$

where wᵢ are time-dependent weights. Because \dot{x} and V₍ᵢ₎ transform as contravariant vectors (except for a possible global permutation and/or reflection), the weights wᵢ must transform as scalars or invariants; i.e., they are independent of the coordinate system in which they are computed (except for a possible permutation and/or reflection). Therefore, the time-dependent weights, wᵢ(t), provide an inner (coordinate-system-independent) description of the system's velocity in state space. Two observers, who use different sensors (and, therefore, different state space coordinate systems), will derive the same inner time series, except for a possible global permutation and/or reflection.

This equation can be integrated over the time interval [t₀, t] to give an expression for the system's state during that time interval

$$x ( t ) = x ( {t}_{0} ) + {\int }_{{t}_{0}}^{t} {\sum }_{1 \leq i \leq N} {w}_{i} ( t ) {V}_{( i )} [ x ( t ) ] dt , \qquad ( 9 )$$

This is an integral equation for constructing x(t) on the interval [t₀, t] from the weight time series, wᵢ(t), on the same time interval. Note that, given a set of local vectors, there is a many-to-one correspondence between the set of measurement time series and corresponding inner time series. Specifically, Eq. (8) shows that each measurement time series maps onto just one weight time series. However, as shown by Eq. (9), one weight time series maps onto multiple measurement time series, differing by the choice of the initial point, x(t₀).

### 2 INNER TIME SERIES OF COMPOSITE SYSTEMS

Now, consider the special case in which the observed system is composite (or separable) in the sense that it consists of two statistically independent subsystems. Specifically, assume that there is a state space coordinate system, s, in which the state components (sₖ(t) for k=1, . . . , N) can be partitioned into two groups, s₍₁₎=(sₖ for k=1, . . . , N₁) and s₍₂₎=(sₖ for k=N₁+1, . . . , N), that are statistically independent in the following sense. Let ρ_{S}(s, \dot{s}) be the PDF in (s, \dot{s})-space. Namely, ρ_{S}(s, \dot{s})dsd\dot{s} is the fraction of total time that the location and velocity of s(t) are within the volume element dsd\dot{s} at location (s, \dot{s}). The subsystem state variables, s₍₁₎ and s₍₂₎, are assumed to be statistically independent in the sense that the density function of the system variable is the product of the density functions of the two subsystem variables; i.e.,

$${ρ}_{S} ( s , \dot{s} ) = {\prod }_{a = 1 , 2} {ρ}_{a} ( {s}_{( a )} , {\dot{s}}_{( a )} ) . \qquad ( 10 )$$

In the following paragraphs, it is shown that, if the data are separable in the above sense, the components of the inner time series of the composite system can be partitioned into two groups, each of which provides an inner description of one of the subsystems. Although these results are demonstrated here for systems with two independent subsystems, they can be easily generalized to systems with any number of subsystems.

To prove the above assertion, the first step is to transform Eq. (8) into the s coordinate system, by multiplying each side by ds/dx. Because the V₍ᵢ₎ transform as contravariant vectors (up to a possible permutation and/or reflection), it follows that

$$\dot{s} ( t ) = {\sum }_{1 \leq i , j \leq N} {w}_{i} ( t ) {P}_{ij} {V}_{S ( j )} , \qquad ( 11 )$$

where V_{S(j)} is V₍ⱼ₎ in the s coordinate system and P is a possible permutation and/or reflection. By definition, the V_{S(i)} are the local vectors, which are derived from the local distribution of \dot{s} in the same way that the V₍ᵢ₎ were derived from the local distribution of \dot{x}. Specifically, V_{S(i)} is the i^{th} column of M_{S}⁻¹, where Ms is the M matrix that is derived from the second- and fourth-order velocity correlations in the s coordinate system.

It can be shown that the matrix M_{S} has a simple block-diagonal form. In particular, M_{S} is given by

$${M}_{S} ( s ) = ( \begin{matrix}{M}_{S 1} ( {s}_{( 1 )} ) & 0 \\ 0 & {M}_{S 2} ( {s}_{( 2 )} )\end{matrix} ) . \qquad ( 12 )$$

where each submatrix, M_{Sa} for a=1, 2, satisfies Eq. (5) and Eq. (6) for correlations between components of s₍ₐ₎. Observe that each vector V_{S(i)} vanishes except where it passes through one of the blocks of M_{S}⁻¹. Therefore, equation Eq. (11) is equivalent to a pair of equations, which are formed by projecting it onto each block corresponding to a subsystem state variable. For example, projecting both sides of Eq. (11) onto block a gives the result

$${\dot{s}}_{( a )} ( t ) = {\sum }_{{1 \leq i < N}_{j ∈ block a}} {w}_{i} ( t ) {P}_{ij} {V}_{S ( ja )} . \qquad ( 13 )$$

Here, V_{S(ja)} is the projection of V_{S(j)} onto block a; i.e., it is the column of M_{Sa}⁻¹ that coincides with column j of M_{S}⁻¹, as it passes through block a. This means that the vectors, V_{S(ja)} for jϵblock a, are the local vectors on the s₍ₐ₎ manifold, which are derived from the local distribution of \dot{s}₍ₐ₎ in the same way that the V₍ᵢ₎ were derived from the local distribution of \dot{x}. Notice that each time-dependent weight, wᵢ(t), describes the evolution of just one subsystem. In other words, the weights do not contain a mixture of information about the evolution of the two subsystems. This is true despite the fact that they can be derived from raw measurements that may be complicated unknown mixtures of the state variables of both subsystems.

Next, define group 1 (group 2) to be the set of weights appearing in the expression

$${\sum }_{1 \leq i \leq N} {w}_{i} {P}_{ij} \qquad ( 14 )$$

for jϵblock 1 (for jϵblock 2). Equation (13) shows that the weights in group 1 (group 2) comprise a sensor-independent description of the velocity of subsystem 1 (subsystem 2). Therefore, if an observed system is composite, its weight components can be partitioned into two groups, which are statistically independent of each other. Conversely, if the weight components of a system can be so partitioned, it is likely to be composite.

### 3 ANALYTIC AND EXPERIMENTAL EXAMPLES

In this section, the inventive method in Sections 1 and 2 is illustrated by applying it to: 1) an analytic example (namely, a time series equal to a sine wave); 2) the audio waveform of a single speaker; 3) nonlinear mixtures of the waveforms of two speakers.

### 3.1 Analytic Example: A Sine Wave

In this subsection, the proposed methodology is applied to a measurement time series, simulated by a sine wave. Its inner time series is derived analytically, before and after it is transformed by an arbitrary monotonic function. The transformed data, which simulate the output of a second sensor, are shown to have the same inner time series as the (untransformed) data from the first simulated sensor.

Suppose the measured sensor signal is

x(t)=a sin(t) (15)

where a is any real number and −∞≤t≤∞. Because of the periodicity of the signal, the local second-order velocity correlation can be shown to be

C₁₁(x)=a²−x². (16)

The 1×1 “matrix”, M, is

M₁₁(x)=±1/\sqrt{a²−x²}, (17)

and the one-component local vector, V₍₁₎(x), is

V₍₁₎₁(x)=±\sqrt{a²−x²}. (18)

Either sign can be chosen in Eq. (17) and Eq. (18) because M is only determined up to a global reflection. Substituting Eq. (15) and Eq. (18) into Eq. (8) shows that the weight time series is

w₁(t)=±sgn[a cos(t)]. (19)

Thus, for this periodic signal, the inner time series is simply the sign of the signal's time derivative. As shown in the following subsections, a much larger amount of information is contained in the inner time series of more complex one-component signals.

The sensor-independence (or coordinate-system-independence) of the inner time series can be demonstrated analytically by computing it from measurements that have been transformed by a monotonic function, ƒ(x), which simulates the relative response of a different sensor. Specifically, consider the transformed measurements given by

x′(t)=ƒ[a sin(t)], (20)

where ƒ is monotonic. The local second-order correlation of the velocity of these measurements is

$${C}_{11}^{′} ( {x}^{′} ) = {[ \frac{df}{dx} a cos ( {t}_{{x}^{′}} ) ]}^{2} , \qquad ( 21 )$$

where dƒ/dx is evaluated at x=a sin(t_{x′}) and where t_{x′} is any solution of ƒ[a sin(t_{x′})]=x′. Because the measurements have just one component, the 1×1 “matrix” M′ is equal to

M′₁₁(x′)=±1/\sqrt{C′₁₁(x′)}, (22)

and the local vector is

V′₍₁₎₁(x′)=±\sqrt{C′₁₁(x′)}. (23)

Substituting Eq. (20) and Eq. (23) into Eq. (8) shows that the weight function is

w′ᵢ(t)=±sgn[a cos(t)]=w₁(t). (24)

Thus, the transformed and untransformed measurements (Eqs. (20) and (15)) have the same inner time series (up to a reflection), This shows that the weights are sensor-independent (and coordinate-system-independent), a fact that was proved in Section 1.

### 3.2 the Audio Signal of a Single Speaker

In this subsection, the proposed method is applied to the audio waveform of a single speaker, before and after it has been transformed by a nonlinear monotonic function, which simulates the relative response of another sensor. The inner time series of the untransformed and transformed signals are shown to be almost the same.

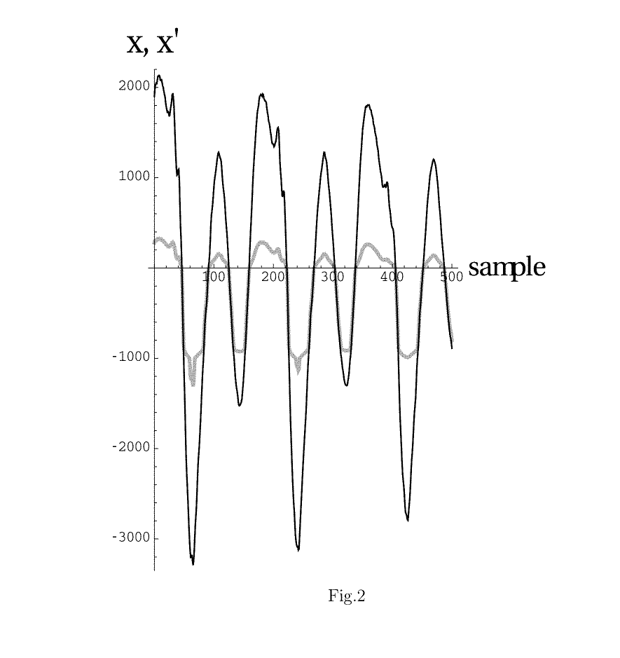

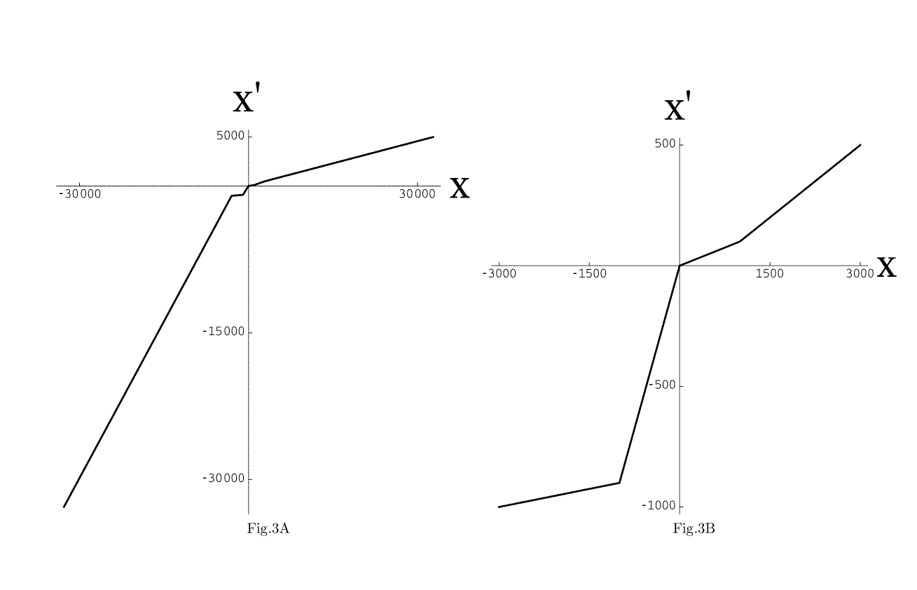

The male speaker's audio waveform, x(t), was a 31.25 s excerpt from an audio book recording. This waveform was sampled 16,000 times per second with two bytes of depth. The thin black line in FIG. 2 shows the speaker's waveform during a 31.25 ms interval. The thick gray line in FIG. 2, x′(t), simulates the output of another sensor, which is related to x(t) by the monotonic nonlinear transformation in FIG. 3.

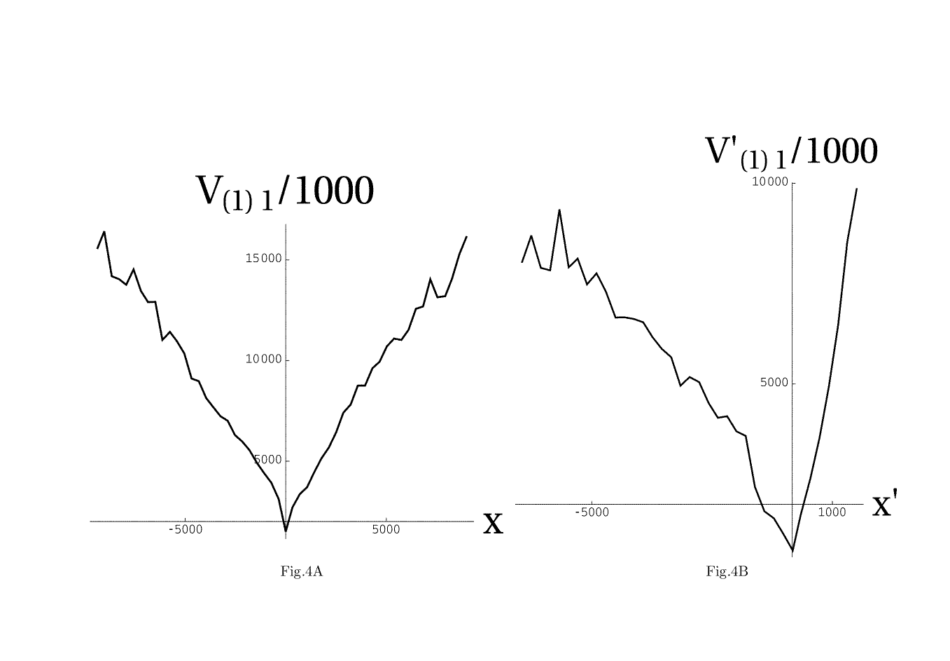

The technique in Section 1 was applied to 500,000 samples of x(t) and x′(t), in order to derive the one-component vectors, V₍₁₎(x) and V′₍₁₎(x′), in an array of 128 bins on the x and x′ manifolds, respectively. These quantities are displayed in FIG. 4.

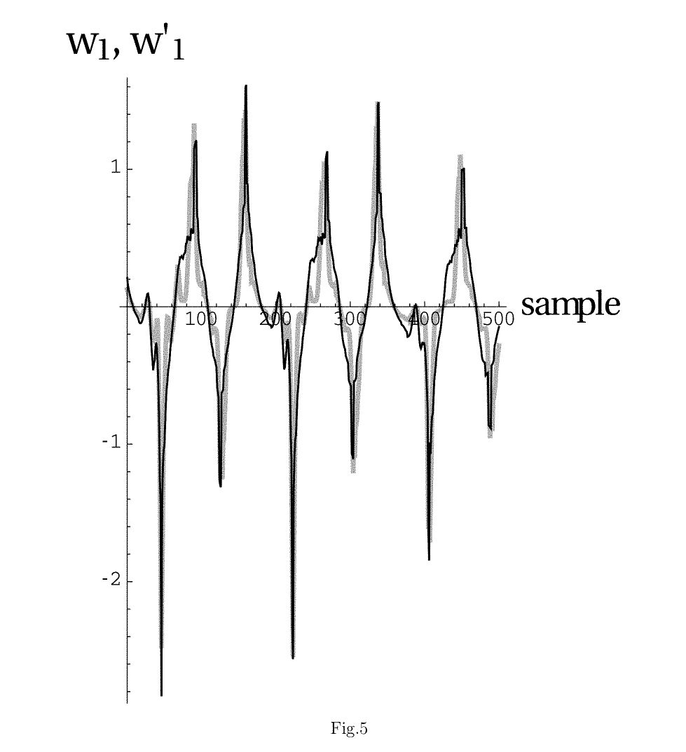

Then, these vectors and equation Eq. (8) were used to compute the inner time series, w₁(t) and w′₁(t), corresponding to the two measurement time series, x(t) and x′(t), respectively. The resulting time series of weights are shown in FIG. 5. Notice that the two inner time series are almost the same, despite the fact that they were derived from sensor measurements, which differed by a nonlinear transformation. This demonstrates the sensor-independence of the weights, a property that was proved in general in Section 1.

When either inner time series was played as an audio file, it sounded like a completely intelligible version of the original audio waveform, x(t). No semantic information was lost, although the prosody of the signal may have been modified. Therefore, in this experiment, almost all of the signal's information content was preserved by the process of deriving its inner time series.

### 3.3 Nonlinear Mixtures of Two Audio Waveforms

In this subsection, the system consists of two speakers, whose utterances are statistically independent and are observed in two ways: 1) as a pair of unmixed signals, each one being the waveform of one speaker; 2) as a pair of nonlinear mixtures of the unmixed signals. The unmixed and mixed pairs of signals simulate measurements made by two observers who were using different sensors. The procedure in Section 1 was applied to derive the inner time series, corresponding to the unmixed and mixed signals. These inner time series are shown to be almost the same, thereby demonstrating their sensor independence. Furthermore, the time series of each weight component, derived from the signal mixtures, is almost the same as the weight time series, derived from one of the unmixed signals. Thus. in this case, the inner time series of a composite system is simply a collection of the inner time series of its statistically independent subsystems, as proved in Section 2.

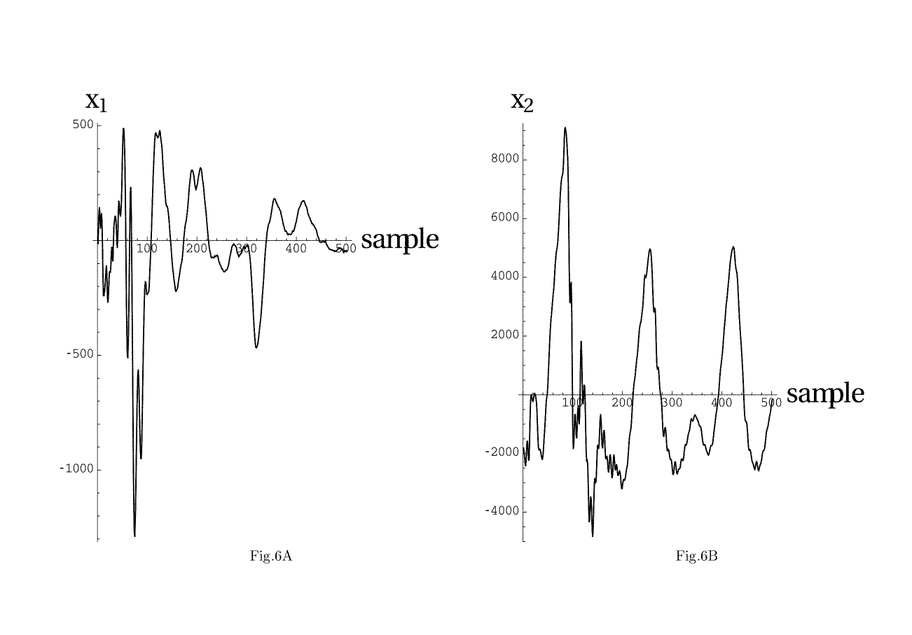

The unmixed signals were excerpts from audio book recordings of two male speakers, who were reading different texts. The two audio waveforms (denoted xₖ(t) for k=1, 2) were 31.25 s long and were sampled 16,000 times per second with two bytes of depth. FIG. 6 shows the two speakers' waveforms during a 31.25 ms interval. These waveforms were then mixed by the nonlinear functions

μ₁(x)=0.763x₁+(958−0.0225x₂)^{1.5}

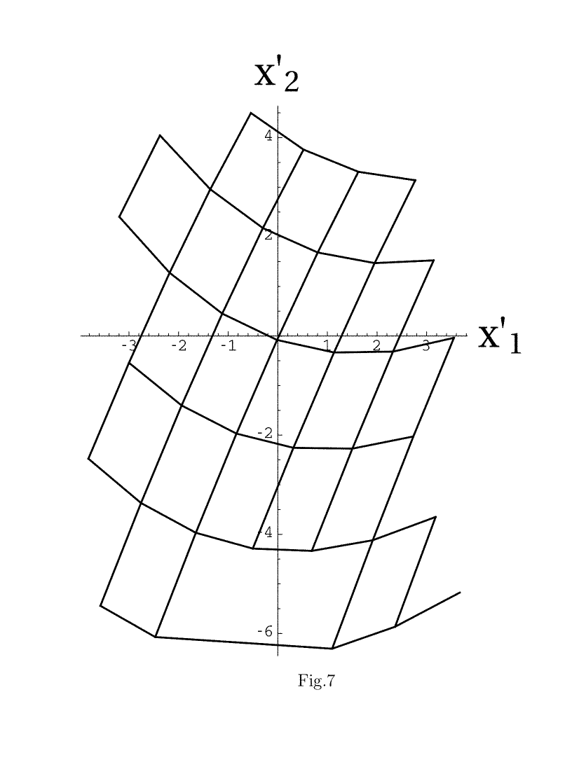

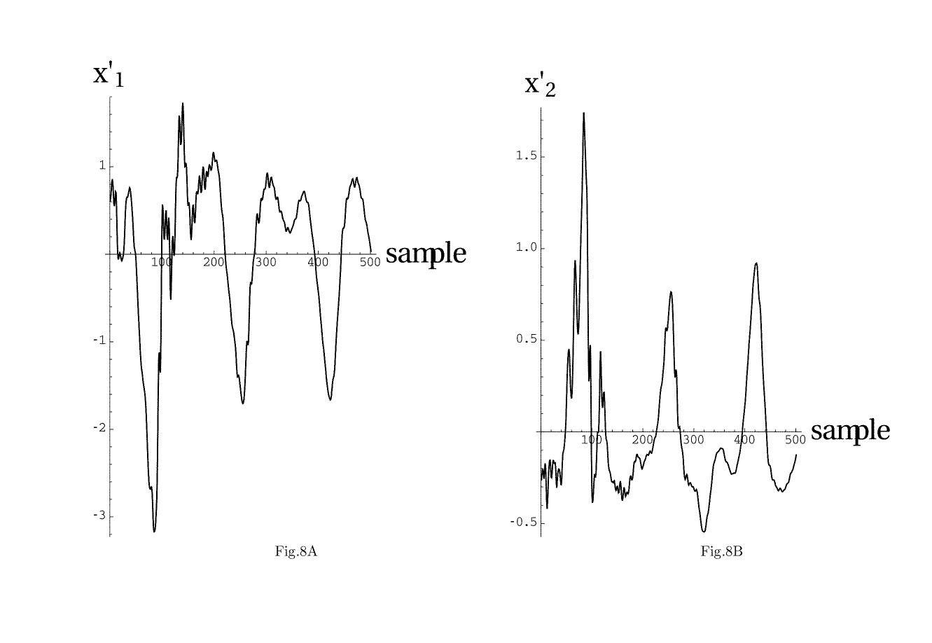

μ₂(x)=0.153x₂+(3.75*10⁷−763x₁−229x₂)^{0.5}, (25)

where −2¹⁵≤x₁, x₂≤2¹⁵. This is one of a variety of nonlinear transformations that were tried with similar results. The mixed measurements, x′ₖ(t), were taken to be the variance-normalized, principal components of the waveform mixtures, μₖ[x(t)]. FIG. 7 shows how this nonlinear mixing function mapped an evenly-spaced Cartesian grid in the x coordinate system onto a warped grid in the x′ coordinate system. Notice that the mapped grid does not “fold over” onto itself, thereby showing that it is an invertible mapping. The lines in FIG. 8 show the time course of x′(t). When either waveform mixture (x′₁(t) or x′₂(t)) was played as an audio file, it sounded like a confusing superposition of two voices, which were quite difficult to understand.

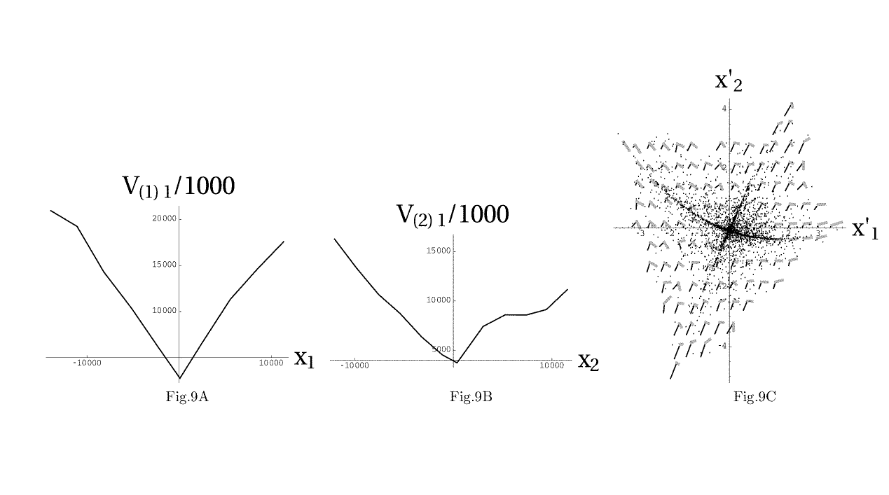

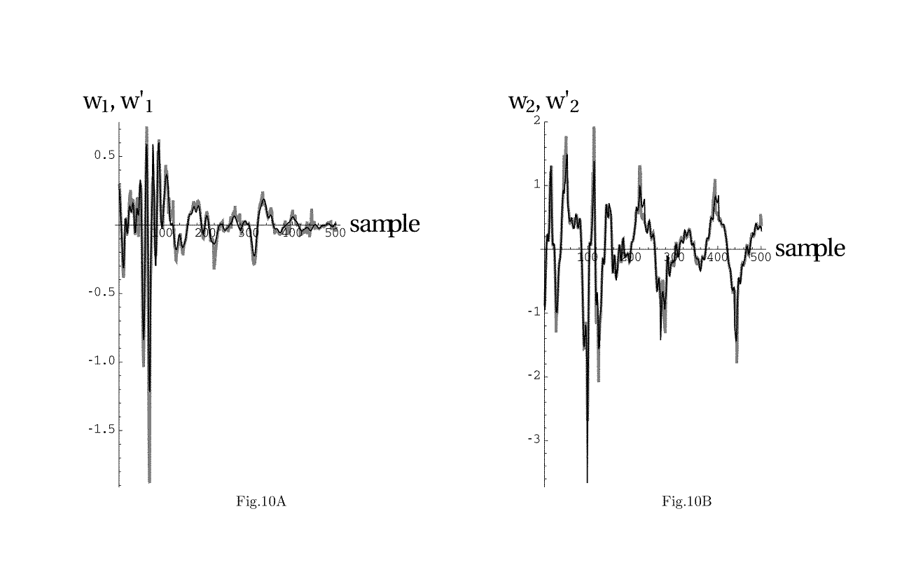

The method in Section 1 was then applied to these data as follows:
1. The 500,000 measurements of the first unmixed waveform, consisting of x₁ and \dot{x}₁ at each sampled time, were sorted into an array of 16 bins in x₁-space. Then, the \dot{x} distribution in each bin was used to compute local velocity correlations, and these were used to derive the one-component local vector, V₍₁₎ (x₁), in each bin in x₁-space. The left panel of FIG. 9 shows these local vectors at each point. These vectors and the \dot{x}₁ time series were substituted in Eq. (8) in order to compute the inner time series, w₁(t), for the first unmixed waveform, The result is shown by the thin black line in FIG. 10A.
2. The same procedure was applied to the second unmixed waveform in order to compute its inner time series, w₂(t). The result is shown by the thin black line in FIG. 10B.
3. The 500,000 samples of the mixed waveform, x′(t), were sorted into a 16×16 array of bins in x′-space, and the distribution of velocities, \dot{x}′, in each bin was used to compute the local vectors, V′₍ᵢ₎(x′), at each point. These are shown in panel c of FIG. 9. These vectors and the velocity time series, \dot{x}′(t), were substituted in Eq. (8) to compute the inner time series, w′ᵢ(t), of the mixed waveforms. These are depicted by the thick gray lines in FIG. 10, after they had been multiplied by an overall permutation/reflection matrix.

It is evident that the unmixed and mixed waveforms have inner time series that are almost the same. This demonstrates that an inner time series is not affected by transformations of the measurement time series. In other words, the inner time series encodes sensor-independent information. When each inner time series was played as an audio file, it sounded like a completely intelligible recording of one of the speakers. In each case, the other speaker was not heard, except for a faint buzzing sound in the background. Thus, each inner time series contained all of the semantic information in the unmixed waveform.

Notice that this composite system has an inner time series, w′ᵢ(t), which is equal to the collection of the inner time series of its statistically independent subsystems, w₁(t) and w₂(t). This demonstrates the separability property of the inner time series of a composite system, which was proved in Section 2. Also, notice that the correlation between the time series, w′₁(t) and w′₂(t), is quite low (−0.0016). As discussed in Section 2, this is expected because these are inner time series of two statistically independent subsystems.

### 4 CONCLUSION

This disclosure describes how a time series of sensor measurements can be processed in order to create an inner time series, which is not affected by the nature of the sensors. Specifically, if a system is observed by two sets of sensors, each measurement time series will lead to the same inner time series if the two sets of measurements are related by any instantaneous, invertible, differentiable transformation. In effect, an inner time series contains information about the intrinsic nature of the observed system's evolution, without depending on extrinsic factors, such as the observer's choice of sensors. An inner time series is created by statistically processing the local distributions of measurement velocities in order to derive vectors at each point in measurement space. The system's velocity can then be described as a weighted superposition of the local vectors at each point. These time-dependent weights comprise the inner time series. Because they are independent of the coordinate system in measurement space, they represent sensor-independent information about the system's velocity in state space. Therefore, if a device uses an inner time series of measurements to monitor the state of an evolving physical system, it need not be recalibrated when its sensors are replaced or modified, as long as enough time has elapsed so that the measurement time series is dominated by the cumulative output of the new sensors.

This can be useful in certain practical applications. For instance, it may be used to reduce false negatives in the detection of events of interest. To see this, imagine that the objective is to detect certain “targeted” movements of a system as it moves through state space, and suppose that this is being done by using a pattern recognition technique to monitor the output of sensors that are observing the system. If the pattern recognition software is trained on the output of calibrated sensors, subsequent sensor drift will cause false negatives to occur. This can be avoided if the pattern recognition algorithm is trained on the inner time series, instead of the time series of raw measurements. As long as the local vectors are computed from data from the drifted sensors, the inner time series will not be affected by sensor drift, and the targeted movements will be sensitively detected.

As described in Section 2, an inner time series has another attractive property, in addition to its sensor independence. Namely, it automatically provides a separable description of the evolution of a system that is composite in the sense of Eq. (10). Specifically, consider the sensors that observe such a composite system. They may be sensitive to the movements of many subsystems, causing the raw sensor outputs to be unknown, possibly nonlinear, mixtures of many subsystem state variables. Now, suppose that we compute the time series of multi-component weights derived from such mixture measurements. As proved in Section 2, each component of the inner time series of the composite system is the same as a component of the inner time series of one of its subsystems. In other words, the inner time series of a composite system can be partitioned into groups of components, with each group being equal to the inner time series that would have been derived from a subsystem, if it were possible to observe it alone. Because of this separability property, the inner time series may be useful for detecting a targeted movement of one particular subsystem, in the presence of other independent subsystems. In particular, a pattern recognition procedure can be trained to determine if a subset of the components of the inner time series of a composite system have the same time-dependence as the components of the inner time series of one of its subsystems. Notice that this can be done without performing blind source separation in order to find the unmixing function that transforms the measurement time series into its statistically independent components.

As an illustrative example, consider the system comprised of the two independent speakers, described in Subsection 3.3, and imagine that our objective is to detect an utterance of the first speaker (FIG. 6A) in the presence of the second speaker (FIG. 6B). It is difficult to determine if this targeted signal is present in the mixtures that are actually measured (FIG. 8). However, notice that one of the weight time series, derived from the mixed signals of the composite system (thick gray line in FIG. 10A), is almost the same as the inner time series of the movement of interest, derived from the unmixed waveform of a subsystem (the thin black line in FIG. 10A), Therefore, a pattern recognition procedure, which is trained on the inner time series of the unmixed signal, may recognize the targeted signal, even in the presence of signals from other subsystems.

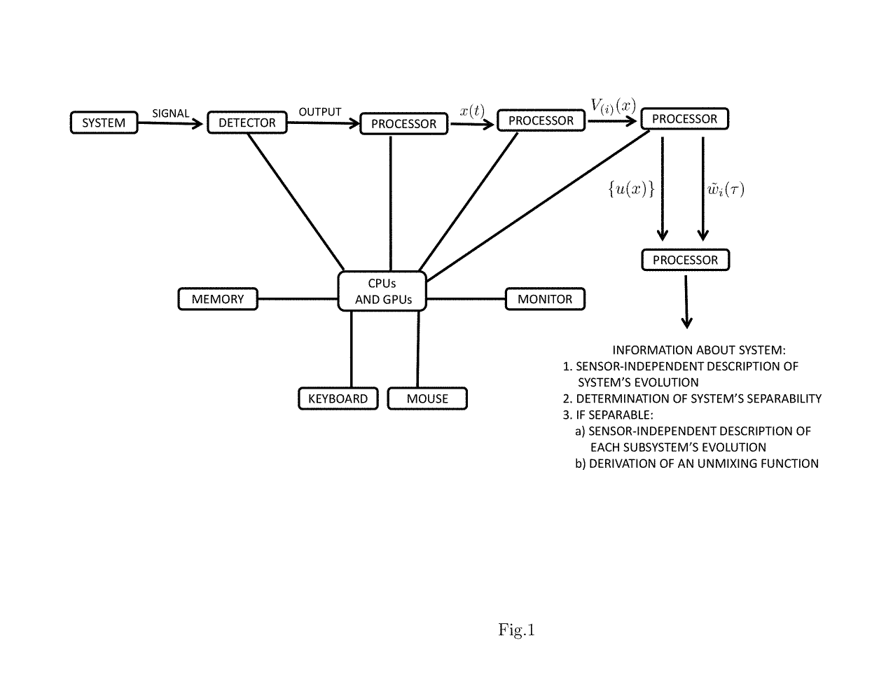

Some comments on these results:
1. As shown in Eq. (8), the inner time series of a trajectory of recent measurements is computed from the local velocity along that trajectory and the local contravariant vectors V₍ᵢ₎(x). Recall that the latter are computed from the second- and fourth-order local correlations of the system's velocity in the past. Therefore, the accurate computation of the inner time series requires enough past data in order to obtain good estimates of these local correlations. This has practical implications. For example, if there is a sudden change in the sensors, which are monitoring a system, it may be necessary to delay the computation of the inner time series while enough measurements are collected for the accurate computation of these correlations.
2. As stated in Background of the Invention, we have assumed that the sensors produce measurements that are invertibly related to the state variables of the underlying system. This invertibility property can almost be guaranteed by observing the system with a sufficiently large number of independent sensors: specifically, by utilizing at least 2N+1 independent sensors, where N is the dimension of the system's state space. In this case, the sensors' output lies in an N-dimensional subspace embedded within a space of at least 2N+1 dimensions. Because an embedding theorem asserts that this subspace is very unlikely to self-intersect, the points in this subspace are almost certainly invertibly related to the system's state space. Then, dimensional reduction techniques can be used to define subspace coordinates (x) that are invertibly related to the state space points, as desired.
3. An inner time series contains information that is intrinsic to the evolution of the observed system, in the sense that it is independent of extrinsic factors, such as the type of sensors used to observe the system. In other words, an inner time series contains information about what is happening “out there in the real world”, independent of how the observer chooses to describe it or experience it. Mathematically speaking, an inner time series is a coordinate-system-independent property of the measurement time series; i.e., its values are the same no matter what measurement coordinate system is used on the system's state space. The local vectors (V₍ᵢ₎) also represent a kind of intrinsic structure on state space. They “mark” state space in a way that is analogous to directional arrows, which are embedded in a physical surface and which can be used as navigational aids, no matter what coordinate system is being used.
4. It is interesting to consider the possible role of inner time series in speech perception. Notice that speech is a communications system with two remarkable properties. First of all, it is listener-independent in the sense that any two listeners will usually perceive an utterance to have the same meaning, despite the fact that they use different sensors to hear it (e.g., different acoustic channels, different outer, middle, and inner ears; different cochleae; different neural architectures of the acoustic cortex). Secondly, speech is speaker-independent in the sense that a listener will effortlessly perceive two speakers to be saying the same thing, even though the message is being conveyed with two different voices. These characteristics of speech can be explained if: 1) the message of each utterance is encoded in its inner time series, and everyone uses the same encoding method (i.e., uses the same inner time series to represent the same object, attribute, event, action, etc.); 2) all listeners and speakers have past exposure to similar sets of sounds, and each one utilizes the contravariant vectors derived from those sounds in order to compute the inner time series of each utterance. It follows that different people will derive approximately the same inner time series from an utterance. In that case, any two listeners with possibly different sensors will derive the same inner time series from an utterance. Therefore, after decoding it, they will perceive its message to be the same (i.e., to be listener-independent). Similarly, if two speakers with different voices intend to convey the same message, they will create utterances that have the same inner time series, although the two utterances may traverse different regions of measurement space. A listener will note that these utterances have the same inner time series and, therefore, that they carry the same message (i.e., a speaker-independent message). Similarly, the instrument-independent and listener-independent message of music may be encoded in its inner time series.
5. Most methods of automatic speech recognition (ASR) utilize acoustic features such as filterbank outputs, mel-frequency cepstral coefficients, etc. These features are speaker-dependent. For example, an utterance may be represented by different filterbank coefficients, depending on the nature of the voice that produced it. This variability in the representation of a message makes it difficult to use these acoustic features to recognize the speech of a variety of speakers. Instead, it may be necessary to train the ASR software narrowly, using training data for a single speaker of interest. Then, this software must be laboriously retrained to recognize the speech of another speaker. In contrast, if the message of an utterance is carried by the weights of its inner time series, as described above, those weights can be used as speaker-independent acoustic features. An ASR engine with those acoustic features can be trained with the speech of just one speaker. Then, it can be used without retraining to recognize the speech of any other speaker. In other words, if the weights of the inner time series contain the message of each utterance, they can be used to create a speaker-independent ASR device.
6. As schematically illustrated in FIG. 1, certain embodiments of the present invention include the use of the following five steps to perform blind source separation of a measurement time series:
   i) The local second- and fourth-order correlations of the measurement velocity (\dot{x}) are computed in small neighborhoods of the measurement space. These correlations are used to compute N local vectors

(V₍ᵢ₎(x) for i=1, . . . ,N).
ii) The V₍ᵢ₎(x) are used to form a small group of N-component functions, {u(x)}, each of which is defined to be the union of two functions, u₍₁₎(x) and u₍₂₎(x). This is done by: a) considering all possible ways of partitioning the vectors into two disjoint non-empty groups with N₁ and N₂ members, respectively; b) for each way of partitioning, constructing u₍₁₎(x) and u₍₂₎(x) so that they have N₁ and N₂ components, respectively, and so that at each point x they are constant along the vectors in the second and first groups, respectively.
iii) Each mapping, u(x), is used to transform the time series of measurements, x(t), into a time series of transformed measurements, u[x(t)].
iv) It is determined if at least one mapping leads to transformed measurements, u[x(t)], having a density function that is the product of the density functions of u₍₁₎[x(t)] and u₍₂₎[(t)].
v) The result of step (iv) is used to determine if the measurement data are separable and, if they are, to determine an unmixing function. Specifically, if at least one mapping, u(x), leads to a factorizable density function, the data are determined to be separable and u(x) is an unmixing function. On the other hand, if none of the mappings leads to a factorizable density function, the data are determined to be inseparable.
   If the measurement data are found to be separable, u₍₁₎[x(t)] and u₍₂₎[x(t)] describe the evolution of statistically independent subsystems. Each of these independent time series can then be studied separately in order to analyze the past evolution of a subsystem and/or to predict aspects of the future behavior of a subsystem.

Specific embodiments of a method and apparatus for sensor-independent representation of time-dependent processes according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

The following comments illustrate the scope of certain embodiments of the invention:
1. The system may be selected from the group including biological system, man-made non-biological system, non-man-made non-biological system, and economic system including business system and market system. Any suitable system may be used depending on the specific application.
2. The evolving system may produce a signal selected from the group including electromagnetic signal, auditory signal, and mechanical signal. Any suitable signal may be used depending on the specific application.
3. The evolving system may produce a signal containing information, including digital information.
4. The signal produced by the system may be carried by a medium selected from the group consisting of empty space, earth's atmosphere, wave-guide, wire, optical fiber, gaseous medium, liquid medium, and solid medium. Any suitable medium may be used depending on the specific application.
5. The detector may be selected from the group of hardware capable of detecting time-dependent signals propagating through a medium, the group consisting of radio antenna, microwave antenna, infrared camera, optical camera, ultra-violet detector, X-ray detector, microphone, hydrophone, pressure transducer, seismic activity detector, density measurement device, temperature detector, translational position detector, angular position detector, translational motion detector, angular motion detector, electrical voltage detector, electrical current detector, and electrical power detector. Any suitable detector may be used depending on the specific application.
6. The detector may also be selected from the group of computer software capable of detecting time-dependent information propagating through a computer network, the group consisting of software that produces output selected from the group including an economic entity's price, an economic entity's value, an economic entity's rate of return on investment, an economic entity's profit, the revenue of an economic entity, an economic entity's debt level, and an interest rate. Any suitable detector may be used depending on the specific application.
7. A sensor state may be produced by processing the output signals of the detector using at least one method selected from the group consisting of a linear procedure, nonlinear procedure, filtering procedure, convolution procedure, Fourier transformation procedure, procedure of decomposition along basis functions, wavelet analysis procedure, dimensional reduction procedure, parameterization procedure, and procedure for rescaling time in one of a linear and nonlinear manner.
8. The processing may be realized by electronic hardware units, including hardware units programmed with software, the hardware units being selected from a group including general purpose computers, general purpose central processing units, graphical processing units, application specific circuits, and digital signal processing circuits and the architecture of the hardware units being selected from a group including von Neumann architecture, neural network architecture, or other architecture and the architecture of the software being selected from a group including general purpose architecture, object-oriented architecture, neural network architecture, or other architecture.

The above considerations are illustrated as follows:
1. In the example described in Section 3.2, the system was a speaker's vocal tract, which is a biological system. The signal was an audio signal, which was emitted by that vocal tract, which propagated through the earth's atmosphere and which was detected by a microphone. The sensor states x(t) were produced by processing the signal with a linear procedure, while the sensor states x′(t) were produced by processing the signal with the nonlinear function illustrated in FIG. 3. The signal processing was done by a general purpose computer with von Neumann architecture.
2. In the example described in Section 3.3, the system consisted of two speakers' vocal tracts, which comprise a biological system. The signal was the collection of audio signals, each of which was emitted by one of those vocal tracts, propagated through the earth's atmosphere, and was detected by a microphone. The sensor states x(t) were produced by processing the signal with a linear procedure, while the sensor states x′(t) were produced by processing the signal with the nonlinear function illustrated in FIG. 7. The signal processing was done by a general purpose computer with von Neumann architecture.
3. In another example, the system is a moving automobile, which is a man-made non-biological system. The signal may consist of optical and infrared light waves, which are types of electromagnetic waves, which are emitted by the automobile, which propagate through the earth's atmosphere, and which are detected by optical and infrared cameras. The sensor states may be produced by processing the camera outputs with linear procedures, such as filtering and Fourier transformation. The processing may be done by application-specific circuits or by general purpose computers with von Neumann architecture.
4. In another example, the system is a market system, such as the market for trading assets (e.g., gold and silver). The activity of the market determines a signal, comprised of the time-dependent prices of unit assets (e.g., the prices of an ounce of gold and an ounce of silver). The signal may propagate across the wires and optical fibers of a computer network and is detected by computer software, which produces output consisting of the time-dependent prices of economic entities (e.g., the prices of gold and silver). The output of the detector may be processed with a linear procedure (such as a short-term Fourier transformation) or with a nonlinear procedure (such as a neural network). The processing may be done with a general purpose computer having von Neumann architecture or with a computer having hardware and/or software with the architecture of a neural network.

What is claimed is:

1. A method of detecting and processing time-dependent signals from an evolving system, comprising:
a) detecting with a detector a signal from the evolving system at a plurality of predetermined time points and providing corresponding output signals;
b) processing, using a processor, the output signals of the detector to produce a sensor state x(t) at each time point in a collection of predetermined time points, each sensor state x(t) including N numbers and N denoting a positive integer;
c) saving in a computer memory, operatively coupled to the processor, the output signals of the detector and the sensor states x(t) at each time point of the collection of predetermined time points;
d) processing, using the processor, at least one of the saved sensor states x(t) in order to determine local second-order correlations Cₖₗ(x) and local fourth-order correlations Cₖₗₘₙ(x) at one or more locations x in the space of possible sensor states, the correlations being determined by
Cₖₗ(x)=<(\dot{x}ₖ−\dot{x̅}ₖ)(\dot{x}ₗ−\dot{x̅}ₗ)>ₓ (26)
Cₖₗₘₙ(X)= [symbol] (\dot{x}ₖ−\dot{x̅}ₖ)(\dot{x}ₗ−\dot{x̅}ₗ)
(\dot{x}ₘ−\dot{x̅}ₘ)(\dot{x}ₙ−\dot{x̅}ₙ) [symbol] ₓ (27)
\dot{x̅} denoting <\dot{x}>ₓ, \dot{x} denoting the time derivative of x(t), the angular brackets denoting the time average of the bracketed quantity over selected sensor states in a predetermined neighborhood of x, and all indices being integers between 1 and N;
e) processing, using the processor, at least one of the saved sensor states x(t), the local correlations Cₖₗ(x), and the local correlations Cₖₗₘₙ(x) to determine N contravariant vectors V₍ᵢ₎(x) at each sensor state x in a predetermined collection of possible sensor states, V₍ᵢ₎(x) denoting an i^{th} vector at the sensor state x, i denoting an integer satisfying 1≤i≤N, each vector having N components, and the contravariant vectors V₍ᵢ₎(x) being produced by the method comprising the steps of:
i) processing, using the processor, the second-order local correlations and the fourth-order local correlations to determine an N×N matrix M(x) at one or more locations x, the matrix M(x) approximately satisfying
$$\begin{matrix}{I}_{kl} ( x ) = {δ}_{kl} & ( 28 ) \\ {\sum }_{1 \leq m \leq N} {I}_{klmn} ( x ) = {D}_{kl} ( x ) , & ( 29 )\end{matrix}$$
δₖₗ denoting the Kronecker delta quantity, D(x) denoting a diagonal N×N matrix, and Iₖₗ(x) and Iₖₗₘₙ (x) denoting
$$\begin{matrix}{I}_{kl} ( x ) = {\sum }_{1 \leq {k}^{′} , {l}^{′} \leq N} {M}_{{kk}^{′}} ( x ) {M}_{{ll}^{′}} ( x ) {C}_{{k}^{′} {l}^{′}} ( x ) , & ( 30 ) \\ {I}_{klmn} ( x ) = {\sum }_{1 \leq {k}^{′} , {l}^{′} , {m}^{′} , {n}^{′} \leq N} {M}_{{kk}^{′}} ( x ) {M}_{{ll}^{′}} ( x ) {M}_{m {m}^{′}} ( x ) {M}_{{nn}^{′}} ( x ) {C}_{{k}^{′} {l}^{′} {m}^{′} {n}^{′}} ( x ) ; & ( 31 )\end{matrix}$$
ii) determining each contravariant vector at x to be a column of M⁻¹ (x), M⁻¹(x) denoting the matrix inverse of M(x);
f) selecting a path in the space of possible sensor states, the values of y(τ) denoting coordinates of the point on the path corresponding to parameter τ and τ denoting a parameter selected from a group consisting of a time parameter and a non-temporal parameter;
g) processing, using the processor, the contravariant vectors and the coordinates of points on the selected path to determine N path weights for each value of τ, \tilde{w}ᵢ(τ) denoting the i^{th} path weight, i denoting an integer satisfying 1≤i≤N, and the path weights approximately satisfying
$$\frac{dy}{d τ} = {\sum }_{1 \leq i \leq N} {\tilde{w}}_{i} ( τ ) {V}_{( i )} [ y ( τ ) ] ; \qquad ( 32 )$$
h) saving in the computer memory the coordinates of the points on the path and the path weights corresponding to the path; and
i) processing, using the processor, at least one of the saved output signals of the detector and the sensor states x(t) at the predetermined time points and the coordinates of points on the path and the path weights corresponding to the path in order to determine selected aspects of the nature of the states of the system as it evolves through states corresponding to the sensor states along the path.

2. The method according to claim 1 wherein the system is selected from the group consisting of a biological system, man-made non-biological system, non-man-made non-biological system, and economic system including business system and market system.

3. The method according to claim 1 wherein the evolving system produces a signal selected from the group consisting of an electromagnetic signal, auditory signal, and mechanical signal.

4. The method according to claim 1 wherein the evolving system produces a digital information signal.

5. The method according to claim 1 wherein the signal produced by the system is carried by a medium selected from the group consisting of empty space, earth's atmosphere, wave-guide, wire, optical fiber, gaseous medium, liquid medium, and solid medium.

6. The method according to claim 1 wherein the detector is selected from the group consisting of a radio antenna, microwave antenna, infrared camera, optical camera, ultra-violet detector, X-ray detector, microphone, hydrophone, pressure transducer, seismic activity detector, density measurement device, temperature detector, translational position detector, angular position detector, translational motion detector, angular motion detector, electrical voltage detector, electrical current detector, and electrical power detector.

7. The method according to claim 1 wherein the detector is selected from the group of computer software configured to detect time-dependent information propagating through a computer network, the group consisting of software that produces output selected from the group including an economic entity's price, an economic entity's value, an economic entity's rate of return on investment, an economic entity's profit, the revenue of an economic entity, an economic entity's debt level, and an interest rate.

8. The method according to claim 1 wherein a sensor state is produced by processing the output signals of the detector using at least one method selected from the group consisting of a linear procedure, nonlinear procedure, filtering procedure, convolution procedure, Fourier transformation procedure, procedure of decomposition along basis functions, wavelet analysis procedure, dimensional reduction procedure, parameterization procedure, and procedure for rescaling time in one of a linear and nonlinear manner.

9. The method according to claim 1 wherein the processing is performed by electronic hardware units, including hardware units programmed with software and selected from a group consisting of general purpose computers, general purpose central processing units, graphical processing units, application specific circuits, and digital signal processing circuits and the architecture of the hardware units being selected from a group including von Neumann architecture, neural network architecture, or other architecture and the architecture of the software being selected from a group including general purpose architecture, object-oriented architecture, neural network architecture, or other architecture.

10. The method according to claim 1 wherein the elements of the diagonal N×N matrix D(x) satisfy a condition selected from the group of conditions at predetermined x, including decreasing in value as the row index of the elements increases in value and increasing in value as the row index of the elements increases in value.

11. The method according to claim 1 wherein the components of M(x)·<\dot{x}>ₓ satisfy a condition selected from the group of conditions at predetermined x, including being greater than or equal to zero and being less than or equal to zero.

12. The method according to claim 1 wherein processing to determine selected aspects of the nature of the states of the system includes using the time-dependent weights to create a coordinate-system-independent description of selected aspects of the nature of the system states corresponding to the sensor states y(τ) along the path.

13. The method according to claim 1 wherein the sensor states y(τ) along the path correspond to the states of a vocal tract during an utterance of the vocal tract and the weights corresponding to the path describe selected aspects of the utterance.

14. The method according to claim 1 wherein the processing to determine selected aspects of the nature of the states of the system is comprised of the steps of:
a) determining that the components of the path weights can be partitioned into two or more groups of components, the weights in each group being statistically independent of the weights in all of the other groups and each group of weight components corresponding to an independent subsystem of the system; and
b) processing a statistically-independent group of weight components to determine selected aspects of the nature of the evolving states of the corresponding independent subsystem, those selected aspects including a coordinate-system-independent description of selected aspects of the subsystem's states as the system evolves along the path.

15. The method according to claim 14 wherein a subsystem corresponding to a statistically-independent group of weight components is a vocal tract and the coordinate-system-independent description of the evolving states of the independent subsystem describes selected aspects of the nature of an utterance of the vocal tract.

16. The method according to claim 1 wherein the weights \tilde{w}ᵢ(τ) are processed by a method comprising the steps of:
a) determining for each value of τ the coordinates of sensor states z(τ) on a synthetic path, the synthetic path being through the space of possible sensor states or being through another space of possible sensor states of another system, the sensor states of the another system having N components, and the coordinates approximately satisfying
$$\frac{dz}{d τ} = {\sum }_{1 \leq i \leq N} {\tilde{w}}_{i} ( τ ) {\hat{V}}_{( i )} [ z ( τ ) ] , \qquad ( 33 )$$
\hat{V}₍ᵢ₎(z) being the local contravariant vectors V₍ᵢ₎(x) on the space of possible sensor states or being local contravariant vectors on the another space of possible sensor states of the another system, and i being an integer satisfying 1≤i≤N;
b) saving in computer memory the coordinates of the sensor states on the selected path and the weights \tilde{w}ᵢ(τ) and the coordinates of the sensor states on the synthetic path; and
c) processing the coordinates of the sensor states on the selected path and the weights \tilde{w}ᵢ(τ) and the coordinates of points on the synthetic path to determine selected aspects of the nature of the system states corresponding to the sensor states on the selected path.

17. The method according to claim 1 wherein the path is selected so that the coordinates of its points y(τ) are equal to the coordinates of a subset of the produced sensor states x(t) at each time point in a collection of predetermined time points.

18. A method of detecting and processing time-dependent signals from an evolving system, comprising:
a) detecting with a detector a signal from the evolving system at a plurality of predetermined time points, and providing corresponding output signals;
b) processing using a processor, output signals of the detector to produce a sensor state x(t) at each time point in a collection of predetermined time points, each sensor state x(t) including N numbers and N denoting a positive integer;
c) saving in a computer memory, operatively coupled to the processor, the output signals of the detector and the sensor states x(t) at each time point of the collection of predetermined time points;
d) processing, using the processor, at least one of the saved sensor states x(t) in order to determine local statistical properties of the collections of the time derivatives of x(t) in small neighborhoods in a predetermined collection of neighborhoods in the space of possible sensor states, the statistical properties including second-order and higher-order correlations of the time derivatives;
e) processing, using the processor, at least one of the saved sensor states x(t) and the local statistical properties to determine N contravariant vectors V₍ᵢ₎(x) at each sensor state x in a predetermined collection of possible sensor states, V₍ᵢ₎(x) denoting an i^{th} vector at sensor state x, i denoting an integer satisfying 1≤i≤N, each vector having N components;
f) selecting a path in the space of possible sensor states, the values of y(τ) denoting coordinates of the point on the selected path corresponding to parameter τ and τ denoting a parameter selected from a group consisting of a time parameter and a non-temporal parameter;
g) processing, using the processor, the contravariant vectors and the coordinates of points on the selected path to determine N path weights for each value of τ, \tilde{w}ᵢ(τ) denoting the i^{th} path weight, i denoting an integer satisfying 1≤i≤N, the path weights approximately satisfying
$$\frac{dy}{d τ} = {\sum }_{1 \leq i \leq N} {\tilde{w}}_{i} ( τ ) {\hat{V}}_{( i )} [ y ( τ ) ] ; \qquad ( 32 )$$
h) saving in the computer memory the coordinates of the points on the path and the path weights corresponding to the path; and
i) processing, using the processor, at least one of the saved output signals of the detector and the sensor states x(t) at the predetermined time points and the coordinates of points on the path and the path weights corresponding to the path to determine selected aspects of the nature of the states of the system producing sensor states y(τ) along the path.

19. The method according to claim 18 wherein processing to determine selected aspects of the nature of the states of the system includes using the time-dependent weights to create a coordinate-system-independent description of selected aspects of the nature of the system states corresponding to the sensor states y(τ) along the path;

20. The method according to claim 18 wherein the processing to determine selected aspects of the nature of the states of the system further comprises:
a) determining that the components of the path weights can be partitioned into two or more groups of components, the weights in each group being statistically independent of the weights in all of the other groups and each group of weight components corresponding to an independent subsystem of the system; and
b) processing a statistically-independent group of weight components to determine selected aspects of the nature of the evolving states of the corresponding independent subsystem, those selected aspects including a coordinate-system-independent description of selected aspects of the nature of the subsystem's states as the system evolves along the path.

21. A method of detecting and processing time-dependent signals from an evolving system, comprising:
a) detecting with a detector a signal from the evolving system at a plurality of predetermined time points;
b) processing, using a processor, output signals of the detector to produce a sensor state x(t) at each time point in a collection of predetermined time points, each sensor state x(t) including N numbers and N denoting an integer greater than or equal to 2;
c) saving in a computer memory, operatively coupled to the processor, the output signals of the detector and the sensor states x(t) at each time point of the collection of predetermined time points;
d) processing, using the processor, at least one of the saved sensor states x(t) in order to determine local second-order correlations Cₖₗ(x) and local fourth-order correlations Cₖₗₘₙ(x) at one or more locations x in the space of possible sensor states, the correlations being determined by
Cₖₗ(x)=<(\dot{x}ₖ−\dot{x̅}ₖ)(\dot{x}ₗ−\dot{x̅}ₗ)>ₓ (35)
Cₖₗₘₙ(x)= [symbol] (\dot{x}ₖ−\dot{x̅}ₖ)(\dot{x}ₗ−\dot{x̅}ₗ)
(\dot{x}ₘ−\dot{x̅}ₘ)(\dot{x}ₙ−\dot{x̅}ₙ) [symbol] ₓ (36)
\dot{x̅} denoting <\dot{x}>ₓ, \dot{x} denoting the time derivative of x(t), the angular brackets denoting the time average of the bracketed quantity over selected sensor states in a predetermined neighborhood of x, and all indices being integers between 1 and N;
e) processing, using the processor, at least one of the saved sensor states x(t), the local correlations Cₖₗ(x), and the local correlations Cₖₗₘₙ(x) to determine N contravariant vectors V₍ᵢ₎(x) at each sensor state x in a predetermined collection of possible sensor states, V₍ᵢ₎(x) denoting the i^{th} vector at the sensor state x, i denoting an integer satisfying
1≤i≤N, each vector having N components, and the contravariant vectors V₍ᵢ₎(x) bring produced by the method comprising the steps of:
i) processing, using the processor, the second-order local correlations and the fourth-order local correlations to determine an N×N matrix M(x) at one or more locations x, the matrix M(x) approximately satisfying
$$\begin{matrix}{I}_{kl} ( x ) = {δ}_{kl} & ( 37 ) \\ {\sum }_{1 \leq m \leq N} {I}_{klmn} ( x ) = {D}_{kl} ( x ) , & ( 38 )\end{matrix}$$
δₖₗ denoting the Kronecker delta quantity, D(x) denoting a diagonal N×N matrix, and Iₖₗ(x) and Iₖₗₘₙ(x) denoting
$$\begin{matrix}{I}_{kl} ( x ) = {\sum }_{1 \leq {k}^{′} , {l}^{′} \leq N} {M}_{{kk}^{′}} ( x ) {M}_{{ll}^{′}} ( x ) {C}_{{k}^{′} {l}^{′}} ( x ) , & ( 39 ) \\ {I}_{klmn} ( x ) = {\sum }_{1 \leq {k}^{′} , {l}^{′} , {m}^{′} , {n}^{′} \leq N} {M}_{{kk}^{′}} ( x ) {M}_{{ll}^{′}} ( x ) {M}_{m {m}^{′}} ( x ) {M}_{{nn}^{′}} ( x ) {C}_{{k}^{′} {l}^{′} {m}^{′} {n}^{′}} ( x ) ; & ( 40 )\end{matrix}$$
ii) determining each of the contravariant vectors at x to be a column of M⁻¹(x), M⁻¹(x) denoting the matrix inverse of M(x);
f) determining all ways of partitioning the vectors V₍ᵢ₎(x) into two non-empty disjoint groups, comprising a first group and a second group containing N₁ and N₂ vectors, respectively, and N₁ and N₂ being integers greater than or equal to one;
g) for each way of partitioning the V₍ᵢ₎(x) into two groups, using the contravariant vectors to construct a first function of x having N₁ components, the first function being constant at each x along the local vectors in the second group, and using the contravariant vectors to construct a second function of x having N₂ components, the second function being constant at each x along the local vectors in the first group;
h) for each way of partitioning the V₍ᵢ₎(x) into two groups, constructing an N-component function, u(x), by forming the union of the first function and the second function, constructed for that way of partitioning;
i) determining the sensor state data x(t) to be separable if at least one of the functions u(x) is an unmixing function that transforms the probability density function of the data x(t) into a factorizable form;
j) determining the sensor state data x(t) to be inseparable if none of the functions u(x) transforms the probability density function of the data x(t) into a factorizable form; and
k) processing at least one of the saved output signals of the detector and the sensor states x(t) at the predetermined time points, the determination of inseparability, and the determination of separability, and the form of the unmixing function in order to determine selected aspects of the evolution of the system and to determine selected aspects of the evolution of each statistically independent subsystem.
